(19) United States
(12) Patent Application Publication
(10) Pub. No.: US 2004/0030029 A1
(43) Pub. Date: Feb. 12, 2004

(54) Polyester compositions for hot-fill containers

(76) Inventors: Stephen Weinhold, Kingsport, TN (US); Lavonna Suzanne Buehrig, Kingsport, TN (US); Robert Noah Estep, Kingsport, TN (US); David Paul Fischer, Kingsport, TN (US)

Correspondence Address: Karen A. Harding, Eastman Chemical Company, P.O. Box 511, Kingsport, TN, 37662-5075, US

(21) Appl. No.: 09/898,621

(22) Filed: Jul. 3, 2001

Related U.S. Application Data
(60) Provisional application No. 60/254,121, filed on Dec. 8, 2000.

(51) Int. Cl. C08K 3/04; C08K 3/08

(52) U.S. Cl. 524/496; 524/439

(57) ABSTRACT

Disclosed is a polyester composition comprising:

I. a polyester consisting essentially of (i) diacid residues consisting essentially of terephthalic residues; and (ii) diol residues consisting essentially of about 92 to 98 mole percent ethylene glycol residues, about 1 to 4 mole percent diethylene glycol (DEG) residues, and about 1 to 4 mole percent 1,4-cyclohexanedimethanol (CHDM) residues; and having an inherent viscosity (IhV)which satisfies the equations IhV−X−Y=0.74 to 0.80, wherein X is the mole fraction of CHDM and Y is the mole fraction of DEG; and

II. at least one reheat enhancing aid in an amount sufficient to provide between about 5 and 25% reheat improvement. Also disclosed are heat set containers suitable for packaging hot-filled liquids and processes for the manufacture of such heat set containers.

### CROSS REFERENCE TO RELATED APPLICATION

This application claims the benefit of U.S. Provisional Application Serial No. 60/254,121 filed Dec. 8, 2000.

### FIELD OF THE INVENTION

The present invention pertains to certain polyester compositions which are particularly suitable for the manufacture of heatset-formed articles, such as containers. More specifically, the present invention pertains to polyester compositions comprising residues of terephthalic acid, ethylene glycol, diethylene glycol (DEG) and cyclohexane dimethanol (CHDM), and a reheat enhancing aid.

### BACKGROUND OF THE INVENTION

It is well known in the art that poly(ethylene terephthalate) (PET) and PET containing minor amounts of another monomer such as isophthalic acid and/or CHDM is useful for many packaging applications such as in the manufacture of beverage and food containers. Containers for certain applications require a special heat set process. For example, plastic containers which are useful for many foods and juices are hot filled (the contents of the container are at an elevated temperature when introduced into the container). These “hot-fill” containers must be heat-treated or “heat-set” to prevent unacceptable shrinkage or deformation of the polyester container during the hot-fill process. Heat-setting requires the use of heated blow molds and also requires the blow molding process be slowed relative to the typical speeds used for manufacturing non-heat-set containers to obtain a sufficiently long contact time between the blow-molded container and the hot-blow mold. This causes an increase in the cost of manufacturing heatset containers as compared to the manufacture of non-heat-set containers.

In the manufacture of containers such as bottles from thermoplastic polyesters, a bottle preform is heated above the glass transition temperature of the polyester and then positioned in the bottle mold. A pressurized gas such as air then is fed or injected into the heated preform through its open end causing the preform to stretch and expand into the bottle mold. The bottle preforms are test tube shaped articles prepared by injection molding of the polyester. Such technology is well known to the art as shown by U.S. Pat. No. 3,733,309. Any radiant energy source such as quartz heaters, resistance heaters, and the like may be employed.

The highest temperature to which a preform may be reheated is limited by a number of factors which are dependent upon characteristics of the polyester composition from which the preforms are molded. Unfortunately, changing one of the factors to improve a desired property frequently has a detrimental effect on another property. For example, thermally induced crystallization of the preform during reheat—that is, crystallization of the polyester composition from the glass—increases rapidly with temperature. Such crystallinity in the preform causes visible haze in the resultant container, which is unacceptable. While the rate of crystallization from the glass may be reduced by modifying the polyester composition with various diacid or diol comonomers, such modification reduces the level of strain induced crystallinity in the blow molded container and increases the natural stretch ratio of the polyester composition, making it difficult or impossible to achieve good material distribution in the blow molded container.

Other copolymer properties have similar countervailing effects. Molecular weight or solution inherent viscosity (IhV) can, within limits, reduce preform gravitational deformation (droop) and the natural stretch ratio of the polyester composition. Unfortunately, increasing IhV causes the polyester composition to be more costly to manufacture and also, when the IhV exceeds a certain level, dependent upon the particular injection molding equipment used, increases the preform injection molding cycle time due to the higher melt viscosity of the composition causing an increase in the injection time.

Copending U.S. patent application Ser. No. 320,783 filed May 27, 1999, discloses the use of a reheat enhancing aid to improve the rate of crystallization of the finish (the treated portion of the container which receives the cap). U.S. Pat. No. 6,022,920 discloses the use of black iron oxide as a reheat aid which imparts surprisingly little color to colorless containers. Neither the pending application or patent disclose comonomer and/or inherent viscosity (IhV) ranges which are necessary to provide a resin having improved heatset processability and low shrinkage.

Copolymerizable compounds which absorb radiation in the UV range have been disclosed in U.S. Pat. No. 4,617,374.

### SUMMARY OF THE INVENTION

The present invention provides a polyester composition having improved processability in the manufacture of heat-set containers and, thus, may be used to produce heat-set containers having improved hot-fill stability; i.e., containers which exhibit less shrinkage and deformation when hot-filled. The polyester compositions of the present invention comprise:

I. a polyester consisting essentially of:

(i) diacid residues consisting essentially of terephthalic residues; and

(ii) diol residues consisting essentially of about 92 to 98 mole percent ethylene glycol residues, about 1 to 4 mole percent diethylene glycol (DEG) residues, and about 1 to 4 mole percent 1,4-cyclohexane dimethanol (CHDM) residues;

and having an inherent viscosity (IhV) which satisfies the equations IhV−X−Y=0.74 to 0.80, wherein X is the mole fraction of CHDM and Y is the mole fraction of DEG; and

II. at least one reheat enhancing aid in an amount sufficient to provide between about 5 and 35% reheat improvement.

As used herein, inherent viscosity (IhV) is measured at 25° C . using 0.5 grams of polymer per 100 ml of a solvent consisting of 60% by weight phenol and 40% by weight tetrachloroethane.

A second embodiment of the present invention concerns a process for forming a heat-set container which comprises the steps of:

(1) injection molding the above-described polyester composition to form a container perform;

(2) reheating (in the case of two-stage blow molding) or temperature conditioning of (in the case of single-stage blow molding) the preform; and

(3) stretch blow molding of the preform into a mold heated at a temperature of about 90 to 1600° C.

Another embodiment of the present invention pertains to a heat-set container formed from the above-described polyester composition.

The improved polyester compositions of the present invention may be injection molded to produce container preforms which are capable of forming heat-set containers having low visual haze and less than 3% volume shrinkage, even at reduced mold temperatures, e.g., those less than about 130° C., and even those less than about 110° C. The present invention is based, in part, upon the discovery that the temperature of the preform achieved during reheat or conditioning is directly correlated to the hotfill stability of the resultant container. More specifically, we have found that the higher the temperature of the preform at the moment it is blow molded into the container, the greater the hot-fill stability of the container. It has further been discovered that very hot preforms permit the temperature of the blow mold, i.e., the mold into which a heated preform is blown to form a container, to be reduced while still producing containers having acceptable hot-fill stability. Reducing the blow mold temperature provides greater safety, lower energy consumption, less thermally-induced degradation to components of the blow molding machine, less shrinkage and deformation of the container within the blow mold during the period after the high pressure blow air is exhausted from the container and when the container is ejected from the mold, and, potentially, the use of water instead of oil to heat the blow molds. We also have found that the use of preforms molded from the polyester compositions of the present invention enables the blow molding machine to be operated at significantly higher speeds with no reduction of container hot-fill stability.

The maximum temperature to which a preform can be reheated is limited by the reheat rate of the polyester composition; i.e., the proportion of the incident radiation of infrared and visible wavelengths to which the preform is exposed to during reheat which is actually absorbed by the polyester composition. We have discovered that increasing the reheat rate of the polyester composition of the present invention produces advantageous results. In particular, though bound by no theory, it is believed that increasing the reheat rate of the polyester composition alters the temperature profile through the wall of the preform during reheat in a manner that beneficially affects the hot-fill stability of the container. Also, increasing the reheat rate of the novel polyester composition allows the preform to be reheated more quickly such that it experiences for a shorter length of time the high temperature at which crystallization from the glass occurs. Due to the shorter required duration of high temperature exposure, increasing the reheat rate of the polyester composition allows the preform to be reheated to a higher temperature without crystallization from the glass occurring. As mentioned above, this improves the hot-fill stability of the container. The most beneficial means to shorten the duration of reheat is to operate the blow molding machine more quickly, such that the preform passes through the oven more quickly. This reduces the cost of manufacturing the container.

It can be appreciated from the foregoing discussion that the many factors limiting the maximum preform temperature and the resultant container hot-fill stability are complex and deeply interrelated to the degree that a priori prediction of the consequences of altering a characteristic of the polyester composition is impossible even to those most skilled in the art. Thus, it was surprising to discover an interdependent range of copolymer modification, inherent viscosity, and reheat rate via the addition of a reheat rate enhancing additive that yields polyester compositions which produce heatset containers having markedly superior hot-fill stability relative to containers made from compositions outside of identified range.

### DETAILED DESCRIPTION OF THE INVENTION

The polyester component of our novel compositions consists essentially of:

(i) diacid residues consisting essentially of terephthalic residues; and

(ii) diol residues consisting essentially of about 92 to 98 mole percent ethylene glycol residues, about 1 to 4 mole percent diethylene glycol (DEG) residues, and about 1 to 4 mole percent 1,4-cyclohexane-dimethanol (CHDM) residues;

and having an inherent viscosity (IhV, in dl/g)which satisfies the equations IhV−X−Y=0.74 to 0.80, wherein X is the mole fraction (as a decimal value) of CHDM and Y is the mole fraction (as a decimal value) of DEG. The total mole percentage of all components or residues of the polyester is 200 mole percent: 100 mole percent diacid residues and 100 mole percent diol residues. As mentioned above, inherent viscosity (IhV) is measured at 25° C. using 0.5 grams of polymer per 100 ml of a solvent consisting of 60% by weight phenol and 40% by weight tetrachloroethane and is given in dl/g units of measurement.

The polyester component preferably consists essentially of:

(i) diacid residues consisting essentially of terephthalic residues; and

(ii) diol residues consisting essentially of about 94.5 to 97.5 mole percent ethylene glycol residues, about 1.5 to 3 mole percent diethylene glycol (DEG) residues, and about 1 to 2.5 mole percent 1,4-cyclohexane dimethanol (CHDM) residues;

and has an inherent viscosity (IhV, in dl/g)which satisfies the equations IhV−X−Y=0.76 to 0.80, wherein X is the mole fraction (as a decimal value) of CHDM and Y is the mole fraction (as a decimal value) of DEG.

The polyester component of the compositions of the present invention is formed via conventional polyesterification. The three polymerization stages are hereinafter referred to as the esterification stage, the prepolymer stage, and the polycondensation stage. The basic conditions which define these three stages are set out below for convenience and clarity.

In the first stage of the melt-phase process, a mixture of polyester monomer (terephthalic acid and diglycol esters thereof) and oligomers are produced by conventional, well-known processes. The ester exchange or esterification reaction is conducted at a temperature between 220° C. to about 250° C. and a pressure of about 0 to 6.9 bars gauge (100 pounds per square inch—psig) in the presence of suitable ester exchange catalysts such as lithium, magnesium, calcium, manganese, cobalt and zinc, or esterification catalysis such as hydrogen or titanium suitable forms of which are generally known in the art. The catalysts may be used separately or in combination. Preferably, the total amount of catalyst is less than about 200 ppm on an elemental basis. Suitable colorants or toners and/or ultraviolet (UV) light absorbers or stabilizers, especially those that react or polymerize with the polyester polymer, also may be added at this point to control the final color or other properties of the polyester. The reaction is conducted for about 1 to about 4 hours. It should be understood that generally the lower the reaction temperature, the longer the reaction will have to be conducted.

Generally, at the end of the esterification, a polycondensation catalyst is added. Suitable polycondensation catalysts include salts of titanium, gallium, germanium, tin, and antimony, preferably antimony or germanium or a mixture thereof. Preferably the amount of catalyst added is between about 90 and about 350 ppm when germanium or antimony is used. Suitable forms such as, but not limited to, antimony oxide are well known in the art. The prepolymer reaction is conducted at a temperature less than about 280° C., and preferably between about 240° C. and about 280° C. at a pressure sufficient to aid in removing reaction products such as ethylene glycol. The monomer and oligomer mixture typically is produced continuously in a series of one or more reactors operating at elevated temperature and pressure less than one atmosphere. Alternatively, the monomer and oligomer mixture may be produced in one or more batch reactors.

Next, the mixture of polyester monomer and oligomers undergoes melt-phase polycondensation to produce a low molecular weight precursor polymer. The precursor is produced in a series of one or more reactors operating at elevated temperatures. To facilitate removal of excess glycols, water, alcohols, aldehydes, and other reaction products, the polycondensation reactors are run under a vacuum or purged with an inert gas. Inert gas is any gas which does not cause unwanted reaction or product characteristics at reaction conditions. Suitable gases include, but are not limited to CO₂, argon, helium and nitrogen.

Temperatures for this step are generally between about 240° C. to about 280° C. and a pressure between about 0 and about 2 Torr. Once the desired inherent viscosity (IhV) is achieved, the polymer is pelletized. Precursor IhV generally is below about 0.7 dl/g to maintain good color. The target IhV generally is selected to balance good color and minimize the amount of solid stating which is required. The composition of the polyester employed in the present invention was determined by hydrolysis GC and ¹H-NMR. One of the benefits of the present invention is that the polyester component may be prepared from either terephthalic acid or dimethyl terephthalate based polyesters.

The IhV of the polyester component typically is in the range of about 0.76 to 0.88 dl/g provided that the IhV (in dl/g) satisfies the equations IhV−X−Y=0.74 to 0.80, wherein X is the mole fraction of CHDM and Y is the mole fraction of DEG. To illustrate, if the diol component of the polyester contains 2 mole percent CHDM residues and 2 mole percent DEG residues, the polyester has an IhV 0.78 to 0.84, e.g., 0.78−0.02−0.02=0.74 and 0.84−0.02−0.02=0.80. The IhV of the polyester component preferably is in the range of 0.78 to 0.84 dl/g.

The polyester component of the compositions of the present invention comprises residues of terephthalic acid, ethylene glycol, diethylene glycol, and cyclohexanedimethanol. The term “residue” as used herein to describe the composition of the polyester refers to the moiety that is the resulting reaction product of the chemical monomer in a particular reaction scheme, or subsequent formulation or chemical product, regardless of whether the moiety is actually obtained from the chemical species. For example, the terephthalic acid residues may be derived from terephthalic acid, a diester of terephthalic acid such as dimethyl terephthalate and bis(2-hydroxyethyl) terephthalate, or a bis-acid chloride of terephthalic acid such as terephthaloyl chloride. The 1,4cyclohexanedimethanol used in the preparation of the polyester component may be the cis, trans or cis/trans mixtures.

The polyester compositions of the present invention contain at least one reheat enhancing aid in an amount sufficient to provide between about 5 and 35% reheat improvement as compared to M&G 8006 PET. Reheat rate is defined as the change in average temperature of a molded part as a function of exposure to a radiant heat source for a specified time. Suitable reheat rate-increasing additives are well known in the art and include, preferably, black and gray body absorbers such as carbon black, antimony metal, iron oxide and the like, as well as near infrared absorbing dyes, including, but not limited to those disclosed in U.S. Pat. No. 6,197,851, which is incorporated herein by reference.

The reheat enhancing additive should be present in an amount sufficient to improve the reheat rate of the unmodified polyester. The actual amount of reheat rate-increasing additive will vary depending on which additive is used. For the compositions of the present invention the selected reheat enhancing aid should be present in an amount sufficient to improve the reheat of the polyester by at least about 5% when compared to M&G 8006 PET. Concentrations of 1 to about 300 parts per million by weight (ppmw), preferably 3 to about 100 ppmw, normally are sufficient. The reheat rate-increasing additive may be any reheat rate-increasing additive used in the art, including, but not limited to, carbon black, iron oxide, antimony, tin, copper, silver, gold, palladium, platinum or a mixture thereof. However, only very small amounts of black body absorbers, such as carbon black, e.g., about 10 ppmw and less, and black iron oxide, e.g., about 50 ppmw or less, may be necessary to achieve the desired reheat rate, but relatively large amounts of gray body absorbers like antimony metal (about 100 ppmw or less) may be necessary to achieve the same effect. Typically, the polymer composition may comprise antimony metal in a concentration of at least 10 ppm.

The more effective concentration of the iron oxide, for example, is from about 1 to about 100 ppmw, preferably from about 5 to 50 ppmw with 10 to 30 ppmw being most preferred. The iron oxide, which is preferably black, is used in very finely divided form, e.g., from about 0.01 to about 200 μm, preferably from about 0.1 to about 10.0 μm, and most preferably from about 0.2 to about 5.0 μm. Suitable forms of black iron oxide include, but are not limited to magnetite and maghemite. Red iron oxide is less preferred as it imparts an undesirable red hue to the resultant polymer. Such oxides are described, for example, on pages 323-349 of Pigment Handbook, Vol. 1, copyright 1973, John Wiley & Sons, Inc. The reheat enhancing aid, e.g., iron oxide, may be added to the polyester production system during or after polymerization, to the polyester melt, or to the molding powder or pellets from which the bottle preforms are formed. The heating means used for heating the preforms according to the present invention is a quartz lamp, Model Q-1P, 650 W., 120 V., by Smith Victor Corp.

If the metal is used as the reheat rate-increasing additive, the metal preferably is in particle form for ease of processing. The metal particles are preferably sufficiently fine for them not to be visible to the eye and have a range of sizes such that absorption of radiation occurs over a relatively wide part of the wavelength range and not just at one particular wavelength or over a narrow band.

The amount of metal particles present in the thermoplastic polymer composition, as it is to be used in this invention, is a balance between the desired reduction in the reheat time of the polymer, the crystallization of the polymer and the amount of haze that is acceptable for a given application. Preferably, the amount of metal particles is from about 1 ppm to 300 ppm, more particularly from about 5 ppm to 150 ppm, and especially from about 10 ppm to 100 ppm. If desired, masterbatches of the polymer composition containing quantities of metal particles in far higher concentrations can be made for subsequent blending with polymer essentially free from the metal particles to achieve the desired levels of particles.

When antimony is used it may be added to the polymerization reactor in the form of antimony trioxide (antimony (III) oxide), which is a catalyst for the polymerization of the monomers, with a suitable reducing agent such as an acidic phosphorus compound, e.g., phosphonic acid. The polyester monomer melt is a slightly reducing environment, the polyesters may naturally have a very minor proportion of antimony metal present, e.g., up to about 5-6 ppm. However, these low levels of antimony metal do not affect the reheat time significantly, and thus, the reducing agent is required. The use of antimony metal, and its generation in situ, is disclosed in U.S. Pat. No. 5,419,936, which is incorporated herein by reference.

The compositions of the present invention optionally may contain one or more chemically reactive UV absorbing compounds; that is, compounds which are covalently bound to the polyester molecule as either a comonomer, a side group, or an end group. Suitable UV absorbing compounds are thermally stable at polyester processing temperatures, absorb in the range of from about 320 nm to about 380 nm, and are nonextractable from said polymer. The UV absorbing compounds preferably provide less than about 20%, more preferably less than about 10%, transmittance of UV light having a wavelength of 370 nm through a bottle wall 12 mils (305 microns) thick. Suitable UV absorbing compounds include substituted methine compounds of the formula

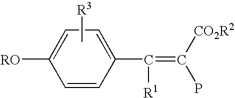

wherein:

R is hydrogen, alkyl, substituted alkyl, aryl, substituted aryl, cycloalkyl, substituted cycloalkyl or alkenyl;

R¹ is hydrogen, or a group such as alkyl, aryl, or cycloalkyl, all of which groups may be substituted;

R² is any radical which does not interfere with condensation with the polyester, such as hydrogen, alkyl, substituted alkyl, allyl, cycloalkyl or aryl;

R³ is hydrogen or 1-3 substitutents selected from alkyl, substituted alkyl, alkoxy, substituted alkoxy and halogen, and

P is cyano, or a group such as carbamyl, aryl, alkylsulfonyl, arylsufonyl, heterocyclic, alkanoyl, or aroyl, all of which groups may be substituted.

Preferred methine compounds are those of the above formula wherein: R² is hydrogen, alkyl, aralkyl, cycloalkyl, cyanoalkyl, alkoxyalkyl, hydroxyalkyl or aryl; R is selected from hydrogen; cycloalkyl; cycloalkyl substituted with one or two of alkyl, alkoxy or halogen; phenyl; phenyl substituted with 1-3 of alkyl, alkoxy, halogen, alkanoylamino, or cyano; straight or branched lower alkenyl; straight or branched alkyl and such alkyl substituted with 1-3 of the following: halogen; cyano; succinimido; glutarimido; phthalimido; phthalimidino; 2-pyrrolidono; cyclohexyl; phenyl; phenyl substituted with alkyl, alkoxy, halogen, cyano, or alkylsufamoyl; vinyl-sulfonyl; acrylamido; sulfamyl; benzoylsulfonicimido; alkylsulfonamido; phenylsulfonamido; alkenylcarbonylamino; groups of the formula

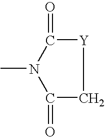

where Y is —NH—, —N-alkyl, —O—, —S—, or —CH₂O—; —S—R₁₄; SO₂CH₂CH₂SR₁₄; wherein R₁₄ is alkyl, phenyl, phenyl substituted with halogen, alkyl, alkoxy, alkanoylamino, or cyano, pyridyl, pyrimidinyl, benzoxazolyl, benzimidazolyl, benzothiazolyl, or a radical of the formulae

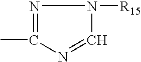

—NHXR₁₆, —CONR₁₅R₁₅, and —SO₂NR₁₅R₁₅ wherein R₁₅ is selected from H, aryl, alkyl, and alkyl substituted with halogen, phenoxy, aryl, —CN, cycloalkyl, alkylsulfonyl, alkylthio, or alkoxy; X is —CO—, —COO—, or —SO₂—, and R₁₆ is selected from alkyl and alkyl substituted with halogen, phenoxy, aryl, cyano, cycloalkyl, alkylsulfonyl, alkylthio, and alkoxy; and when X is —CO—, R₁₆ also can be hydrogen, amino, alkenyl, alkylamino, dialkylamino, arylamino, aryl, or furyl; alkoxy; alkoxy substituted with cyano or alkoxy; phenoxy; or phenoxy substituted with 1-3 alkyl, alkoxy, or halogen substituents; and

P is cyano, carbamyl, N-alkylcarbamyl, N-alkyl-N-arylcarbamyl, N,N-dialkylcarbamyl, N,N-alkylarylcarbamyl, N-arylcarbamyl, N-cyclohexyl-carbamyl, aryl, 2-benzoxazolyl, 2-benzothiazolyl, 2-benzimidazolyl, 1,3,4-thiadiazol-2-yl, 1,3,4-oxadiazol-2-yl, alkylsulfonyl, arylsulfonyl or acyl.

In all of the above definitions the alkyl or divalent aliphatic moieties or portions of the various groups contain from 1-10 carbons, preferably 1-6 carbons, straight or branched chain. Preferred UV absorbing compounds include those where R and R¹ are hydrogen, R³is hydrogen or alkoxy, R² is alkyl or a substituted alkyl, and P is cyano. In this embodiment, a preferred class of substituted alkyl is hydroxy substituted alkyl. A most preferred polyester composition comprises from about 10 to about 700 ppm of the reaction residue of the compound

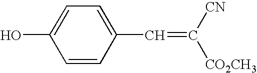

These compounds, their methods of manufacture and incorporation into polyesters are further disclosed in U.S. Pat. No. 4,617,374, the disclosure of which is incorporated herein by reference. The UV absorbing compound(s) may be present in amounts between about 1 to about 5,000 ppm by weight, preferably from about 2 ppm to about 1,500 ppm, and more preferably between about 10 and about 300 ppm by weight. Dimers of the UV absorbing compounds may also be used. Mixtures of two or more UV absorbing compounds may be used. Moreover, because the UV absorbing compounds are reacted with or copolymerized into the backbone of the polymer, the resulting polymers display improved processability including reduced loss of the UV absorbing compound due to plateout and/or volatilization and the like.

The polyester component of the novel polyester compositions consists essentially of residues of terephthalic acid, ethylene glycol, diethylene glycol and 1,4-cyclohexanedimethanol, meaning that the polyester component does not contain significant amounts of other monomer residues which substantially affect the characteristics and properties of the polyesters as described herein. However, it is possible, although not normally desirable, for the polyester component to contain minor amounts of residues of additional monomers such as isophthalic acid and multifunctional monomers such as trimethylolpropane, pentaerythritol, glycerol, trimellitic anhydride, trimethylolpropane, pyromellitic dianhydride, pentaerythritol, trimellitic acid, trimellitic acid, pyromellitic acid and other polyester forming polyacids or polyols generally known in the art.

Also, although not required, optional additives typically used in polyesters may be used if desired. Such additives include, but are not limited to, colorants, pigments, antioxidants, stabilizers, crystallization aids, barrier-improving platelet particles, compounds capable of improving planar stretch ratio, acetaldehyde reducing compounds, oxygen scavenging compounds, and the like.

The polyester compositions of the present invention are suitable for forming a variety of shaped articles, including films, sheets, tubes, preforms, molded articles, containers and the like. Suitable processes for forming said articles are known and include extrusion, extrusion blow molding, melt casting, injection molding, stretch blow molding (SBM), thermoforming, and the like.

Heat set containers may be produced from the novel polyester compositions of the present invention using known injection molding and stretch blow-molding (SBM) processes. These known procedures involve the steps of (i) injecting molding the polyester composition to form a preform and (ii) blowing the heated preform into a container shape. In the first step, the polyester composition is melted in an extruder and the melt is injected into a mold forming a preform, typically a test tube-shaped article with threads molded at the open end. The second step involves blowing of the preform heated at a temperature above the glass transition temperature of the polyester, e.g., typically about 90 to 140° C., more typically about 100 to 130° C. In a “single stage” SBM process, the preform is transferred from the injection mold directly to a blow molding station. During the transfer time, the preform cools to the proper blow molding temperature. In a “two stage” SBM process, the preform is ejected from the injection mold and then held at ambient temperatures for a time long enough to achieve a consistent temperature within the lot of preforms. In a separate step, the preforms are reheated to the proper blow molding temperature before being blown into the desired container shape. In the heat-set process, the preforms are blown into a hot mold, usually at a mold temperature between about 90 and 160° C., more typically between about 100 and 140° C. The hot mold is essential for manufacturing a container having good hot-fill stability. During contact with the hot mold, the crystallinity in the wall of the container is increased and the in-plane orientation of polymer molecules induced by blow molding is reduced. The specific type of process used is determined by the volume of production, or the production rate desired for a specific application, and the machine design and capabilities.

### EXAMPLES

The novel polyester compositions and their use in the manufacture of containers are further illustrated by the following examples. Unless indicated otherwise, parts are by weight, temperature is in °C or is at room temperature and pressure is at or near atmospheric.

The improvement in reheat rate is measured using injection molded flat plaques having the dimensions 7.6 cm×7.6 cm×3.8 mm thick (3 inches ×3 inches ×0.15 inch thick). The plaques were allowed to cool to ambient temperature. A set of four plaques was prepared for each polyester material evaluated. Each plaque was evaluated by placing a plaque in a wooden holder that only contacted the plaque on the edges. The temperature of the plaque in the holder was measured. This was the initial temperature (Ti). The holder was moved into position a fixed distance 12.7 cm (5 inches) from the tip of a GE Quartzline DYH 120V, 600 W, tungsten filament halogen lamp. The lamp temperature during measurement was 3,200 degrees Kelvin. Each plaque was exposed to the illuminated lamp for 35 seconds. The temperature of the plaque then was measures by means of an infrared pyrometer. The temperature was read from the face of the plaque which was not illuminated to allow the heat absorbed by the front surface of the plaque to penetrate through the plaque. The temperature of the back side of the plaque rises at first to a maximum temperature and then begins to fall slowly as the entire plaque cools. The maximum temperature was recorded as the final temperature (T_{f}).

The temperature rise was recorded as ΔT (T_{f}−Tᵢ). The change in temperature also was adjusted for small differences in the thickness of the plaques. The average ΔT for the four plaques was determined from the adjusted ΔT to give a ΔT_{avg} for each polyester material. The ΔT_{avg} for each polyester material was divided by the ΔT of the concurrently tested reference standard to provide the improvement in reheat, or Reheat Index Value (RIV)=(ΔT_{avg} Sample÷ΔT_{avg} Reference).

### Example 1

A polyester consisting of terephthalic acid diacid residues and diol residues consisting of approximately 95 mole percent ethylene glycol residues, about 3.1 mole percent (0.031 mole fraction) DEG residues, and 1.9 mole percent (0.019 mole fraction) CHDM residues having an IhV of approximately 0.82 was prepared from dimethyl terephthalate, ethylene glycol, DEG and CHDM according to the procedures described above. The value of the expression IhV−(mole fraction DEG)−(mole fraction CHDM)=0.82−0.031−0.019 is equal to about 0.77.

Pellets of the above polyester were blended with pellets of a reheat enhancing additive concentrate composed of 99.875 weight percent of a poly(ethylene terephthalate) modified with approximately 3.7 mole percent diethylene glycol (EASTAPAK Polyester 9663) and 0.125 weight percent black iron oxide powder (grade BK45 manufactured by Harcros Pigments, now known as Elementis Pigments) compounded using a 30 mm Werner & Pfleiderer extruder. Pellets of the polyester prepared as described above (49 parts by weight) were blended with pellets of the reheat enhancing additive concentrate (1 part by weight) yielding a polyester consisting of terephthalic acid diacid residues and diol residues consisting of approximately 95 mole percent ethylene glycol residues, about 3.1 mole percent (0.031 mole fraction) DEG residues, and 1.9 mole percent (0.019 mole fraction) CHDM residues having an IhV of approximately 0.82 containing 25 ppmw of black iron oxide.

The performance and properties of the polyester composition of Example 1 were compared to those of the following polyesters:

Comparative Polyester C-1—poly(ethylene terephthalate) modified with approximately 3.7 mole percent DEG residues and having an IhV of about 0.76 (EASTAPAK 9663, Eastman Chemical Company).

Comparative Polyester C-2—a polyester consisting of diacid residues consisting of about 97 mole percent terephthalic acid residues and 3 mole percent isophthalic acid residues and diol residues consisting of approximately 96.7 mole percent ethylene glycol residues and about 3.3 mole percent (0.031 mole fraction) DEG residues having an IhV of approximately 0.82 (PERMACLEAR Lot 61801, Wellman, Inc.).

Comparative Polyester C-3—the polyester prepared as described in Example 1 which does not contain any reheat enhancing additive.

The Reheat Index Value for the composition of Example 1 and Comparative Polyesters C-1, C-2 and C-3 was determined relative to a commercial poly(ethylene terephthalate) (Shell grade 8006 polyester) used in the manufacture of containers by stretch blow molding processes. The Reheat Index Values thus determined were: Example 1=1.17, Comparative Polyester C-1=0.99, Comparative Polyester C-2=1.24, and Comparative Polyester C-3=0.99.

After first drying in a desiccant air dryer, pellets of the polyester composition of Example 1 and Comparative Polyesters C-1, C-2 and C-3 were each molded into preforms using a single cavity Arburg injection molding machine. Each preform weighed about 49 grams and had finish diameter of 43 mm. The injection molding cycle time for each of the four compositions was essentially identical.

Each of the preforms was reheat stretch blow molded into nominal 1 liter bottles using a Sidel SBO-2/3 blow molding machine. This is a rotary blow molding machine having two blow molds and three preform oven zones. The blow mold was designed to produce bottles having vacuum panels, which prevent buckling or collapse of the bottle due to the vacuum generated by hotfilling, sealing, and cooling the bottles. For each composition, four sets of bottles were produced at the following output rates and blow mold temperatures:

1. 800 bottles per hour per mold (BHM) during which oil at a temperature of 138° C. was circulated through the blow mold. This oil temperature yielded a mold surface temperature of 120° C.

2. 1000 BHM during which oil at a temperature of 138° C. was circulated through the blow mold. This oil temperature yielded a mold surface temperature of 120° C.

3. 800 BHM during which oil at a temperature of 118° C. was circulated through the blow mold. This oil temperature yielded a mold surface temperature of 105° C.

4. 1000 BHM during which oil at a temperature of 118° C. was circulated through the blow mold. This oil temperature yielded a mold surface temperature of 105° C.

For each of these four conditions, blow molding machine variables were adjusted to achieve the hottest possible preform surface temperature without generating an objectionable level of haze in the bottle wall, which is indicative of crystallization of the preform during reheat. Additional adjustments to blowing machine variables were also made to maintain the material distribution in the containers, i.e., bottle section weights, within specification. The blowing machine variables adjusted were oven heater profile, overall oven power, preblow timing, preblow air pressure, and preblow air flow rate. These variables and adjustments are well known and understood to those skilled in the art. The preform surface temperature was measured using an infrared pyrometer immediately after the preform had exited the reheat oven. Table 1 shows the preform surface temperature (°C) for the preforms molded from the polyester compositions of Example 1 and Comparative Polyesters C-1 through C-3 (Examples C-1, C-2 and C-3).

TABLE I

Preform Surface Temperature

| Example | 800 BHM | 1000 BHM |
|---|---|---|
| 1 | 106 | 109 |
| C-1 | 99 | 100 |
| C-2 | 101 | 103 |
| C-3 | 104 | 108 |

Table 1 shows that the preforms of Example 1 were heated to substantially higher surface temperature (106 and 109° C.) than the preforms of Comparative Examples 1 (99 and 100° C.) and 2 (101 and 103° C.), and to slightly higher surface temperature than the preforms of Comparative Example 3 (104 and 108° C.). Moreover, changing the oil temperature (and therefore the mold temperature) did not have any significant impact or influence on the preform surface temperature. The Examples clearly show that the compositions of the present invention produce preforms which can be heated to higher temperatures without forming objectionable levels of crystalline haze than similar compositions which are outside the scope of the present invention.

The bottles produced as described above from the composition of Example 1 and Comparative Polyesters C-1, C-2 and C-3 were examined visually for haze under conditions of typical indoor room lighting. Table II shows the level of visual haze exhibited by the bottles blown from the preforms heated to the surface temperatures given in Table I wherein the values given for haze correspond to 0= no haze, 1= very slight haze, 2= slight haze, and 3= moderate haze. The temperatures shown in Table II refers to the temperature of the mold surface.

TABLE II

| Haze in Side-Wall of Blow Molded Bottles | |
|---|---|
| 800 BHM | 1000 BHM |

| Example | 120° C. | 105° C. | 120° C. | 105° C. |
|---|---|---|---|---|
| 1 | 1 | 1 | 1 | 1 |
| C-1 | 3 | 3 | 3 | 3 |
| C-2 | 2 | 2 | 2 | 2 |
| C-3 | 2 | 2 | 0 | 0 |

Table II shows that the level of haze exhibited by the bottles of the Example 1 composition was substantially lower than the level of haze in the bottles of Comparative Polyesters C-1 and C-2 even though the preforms of the Example I composition were heated to substantially higher surface temperature than the preforms of Comparative Polyesters C-1 and C-2. The level of haze in the bottles of the Example 1 composition was similar to the level of haze in the bottles of Comparative Polyester C-3, being slightly lower for bottles blown at the rate of 800 BHM and slightly higher for bottles blown at the rate of 1000 BHM.

The hot-fill stability of the bottles produced as described above was measured using the following procedure. First, the bottles were stored under ambient conditions for a period of about 10 days after blowing to allow the bottles to age and to absorb moisture from the atmosphere which is known to degrade hot-fill stability. Then, the diameter of each bottle was measured at four specified positions (upper bell, lower bell, upper bumper, lower bumper) using a digital caliper. Next, the overflow volume of each bottle was measured by filling it with cold tap water and measuring the net weight of the water using a digital balance. Finally, each bottle was subjected to the following hotfill procedure: (1) quickly fill with water temperature controlled to 85° C.; (2) allow the unsealed bottle to rest on its base for 1 minute; (3) seal the bottle with a threaded closure; (4) allow the sealed bottle to rest on its base for an additional 1 minute; (5) immerse the sealed bottle in a bath of cold tap water until it has cooled to about room temperature.

After the bottles had cooled, they were removed from the cooling bath and while still sealed the maximum and minimum diameter was measured at each of the four specified positions. Hot-fill-induced diameter shrinkage at each of the four positions was calculated using the relation

Diameter Shrinkage=[Di−Dmean]/Di×100%

where Di is the initial diameter of the bottle and Dmean is the arithmetic mean of the maximum and minimum diameters after hotfilling. The arithmetic mean of the diameter shrinkage at the four positions was calculated for a 10 bottle set for each condition and is given as the Average Diameter Shrinkage (%) in Table III.

TABLE III

| Average Diameter Shrinkage | |
|---|---|
| 800 BHM | 1000 BHM |

| Example | 120° C. | 105° C. | 120° C. | 105° C. |
|---|---|---|---|---|
| 1 | 2.05 | 2.61 | 1.82 | 2.49 |
| C-1 | 3.07 | 3.50 | 2.63 | 3.45 |
| C-2 | 2.64 | 3.18 | 2.31 | 2.98 |
| C-3 | 2.20 | 2.81 | 2.86 | 3.92 |

Table III shows that, for each of the blow molding output rates (BHM) and blow mold temperatures (correlated to oil temperature), the Average Diameter Shrinkage for the bottles of the Example 1 composition was significantly less than that for the bottles of Comparative Polyesters C-1, C-22, and C-3. It is generally accepted in the industry that for a bottle to be deemed to have acceptable hot-fill stability, the Average Diameter Shrinkage determined by this procedure must be less than 3%. Table III shows that the bottles of the Example 1 composition comfortably meet this standard for all of the blowing conditions used, even at the lower blow mold temperature. Conversely, the Average Diameter Shrinkage of the bottles of Comparative Examples 1, 2, and 3 blown using the lower mold temperature for the most part exceeds the 3% limit and, in the best of cases, is below but very near the limit. These results clearly show that the bottles of the Example 1 composition have hot-fill stability significantly superior to that of the bottles of Comparative Polyesters C-1, C-2, and C-3.

Bottle ovality caused by hot-filling was calculated as the difference between the maximum and minimum bottle diameters for each of the four specified positions. It is a measure of the degree to which a bottle becomes distorted upon hot-filling. The arithmetic mean of the ovality at the four positions was calculated for a 10 bottle set for each condition and is given in mm as the Average Bottle Ovality in Table IV.

TABLE IV

| Average Bottle Ovality Caused by Hotfilling | |
|---|---|
| 800 BHM | 1000 BHM |

| Example | 120° C. | 105° C. | 120° C. | 105° C. |
|---|---|---|---|---|
| 1 | 0.51 | 0.51 | 0.46 | 0.46 |
| C-1 | 0.71 | 0.74 | 0.74 | 0.92 |
| C-2 | 0.71 | 0.86 | 0.71 | 0.74 |
| C-3 | 0.51 | 0.53 | 0.66 | 0.64 |

Table IV shows that, for each of the blow molding output rates (BHM) and blow mold temperatures (correlated to oil temperature), the Average Bottle Ovality for the bottles produced from the Example 1 composition was significantly less than that for the bottles produced from Comparative Polyesters C-1 and C-2, and for the bottles of Comparative Polyester C-3 at the faster blow molding output rate. This demonstrates that the bottles of the Example 1 composition are more resistant to distortion during hot-filling than are bottles made from commercial resins currently being used in the industry to manufacture heat-set containers.

A different method to evaluate bottle shrinkage caused by hot-filling is to measure the decrease in the bottle overflow volume that occurs due to hot-filling. This measurement was carried out as follows: (1) after aging but prior to hot-filling, the overflow volume of each bottle was measured by weighing the empty bottle on a digital balance; (2) completely filling the bottle with cold tap water; and (3) weighing the filled bottle and subtracting the weight of the empty bottle to calculate the weight of the contained water. The volume of the bottle in cubic centimeters was taken to equal the weight of water in grams. The bottles were emptied of water, hot-filled with 85° C. water as described above, and the volume of the hot-filled bottles was determined in the same manner as detailed above for the bottles prior to hot-filling. The volume shrinkage for each bottle was calculated using the relation:

Volume Shrinkage=[Vi−V]/Vi×100%

wherein Vi is the volume of the bottle before hot-filling and V is the volume of the bottle after hot-filling. The arithmetic mean of the volume shrinkage was calculated for a 10 bottle set for each condition and is given as the Average Volume Shrinkage (%) in Table V.

TABLE V

| Average Volume Shrinkage Caused by Hotfilling | |
|---|---|
| 800 BHM | 1000 BHM |

| Example | 120° C. | 105° C. | 120° C. | 105° C. |
|---|---|---|---|---|
| 1 | 1.91 | 2.63 | 1.87 | 2.74 |
| C-1 | 2.56 | 3.36 | 1.96 | 3.44 |
| C-2 | 2.63 | 3.35 | 2.23 | 3.28 |
| C-3 | 2.30 | 3.00 | 2.11 | 3.85 |

Table V shows that, for each of the blow molding output rates (BHM) and blow mold temperatures (correlated to oil temperature), the Average Volume Shrinkage for the bottles produced from the Example 1 composition was significantly less than that for the bottles produced from Comparative Polyesters C-1, C-2, and C-3. It is generally accepted in the industry that for a bottle to be deemed to have acceptable hoffill stability the Average Volume Shrinkage determined by this procedure must be less than 3%. Table V shows that the bottles of the Example 1 composition meet this standard for all of the blowing conditions used, even at the lower oil (blow mold) temperature. Conversely, the Average Volume Shrinkage of the bottles of the Comparative Polyesters C-1, C-2 and C-3 blown using the lower mold temperature is in each case greater than the acceptable limit. These results clearly show that the bottles of the Example 1 composition have hot-fill stability significantly superior to that of the bottles of Comparative Polyesters C-1, C-2, and C-3.

The invention has been described in detail with particular reference to preferred embodiments thereof, but it will be understood that variations and modifications can be effected within the spirit and scope of the invention.

We claim:

1. A polyester composition comprising:
I. a polyester consisting essentially of:
(i) diacid residues consisting essentially of terephthalic residues; and
(ii) diol residues consisting essentially of ethylene glycol residues, about 1 to 4 mole percent diethylene glycol (DEG) residues, and about 1 to 4 mole percent 1,4-cyclohexanedimethanol (CHDM) residues;
and having an inherent viscosity (IhV, in dl/g) which satisfies the equations IhV−X−Y=0.74 to 0.80, wherein X is the mole fraction of CHDM and Y is the mole fraction of DEG; and
II. at least one reheat enhancing aid in an amount sufficient to provide between about 5 and 35% reheat improvement.

2. The composition of claim 1 wherein polyester component I consists essentially of:
(i) diacid residues consisting essentially of terephthalic residues; and
(ii) diol residues consisting essentially of about 94.5 to 97.5 mole percent ethylene glycol residues, about 1.5 to 3 mole percent DEG residues, and about 1 to 2.5 mole percent CHDM residues;
and has an inherent viscosity (IhV, in dl/g)which satisfies the equations IhV−X−Y=0.76 to 0.80, wherein X is the mole fraction of CHDM and Y is the mole fraction of DEG.

3. The composition of claim 2 wherein said reheat enhancing aid is selected from the group consisting of black and gray body absorbers and near infrared absorbing dyes.

4. The composition of claim 3 wherein said reheat enhancing aid is present in an amount of about 5 to 150 ppm.

5. The composition of claim 4 wherein said reheat enhancing aid is present in an amount of about 10 to 100 ppm.

6. The composition of claim 1 wherein said reheat enhancing aid is selected from the group consisting of carbon black, iron oxide, antimony, tin, copper, silver, gold, palladium, platinum or a mixture thereof.

7. The composition of claim 1 wherein said reheat enhancing aid is selected from the group consisting of carbon black, black iron oxide and antimony metal.

8. A polyester composition comprising:
I. a polyester consisting essentially of:
(i) diacid residues consisting essentially of terephthalic residues; and
(ii) diol residues consisting essentially of about 94.5 to 97.5 mole percent ethylene glycol residues, about 1.5 to 3 mole percent diethylene glycol (DEG) residues, and about 1 to 2.5 mole percent 1,4-cyclohexanedimethanol (CHDM) residues;
and has an inherent viscosity (IhV, in dl/g)which satisfies the equations IhV-X-Y =0.76 to 0.80, wherein X is the mole fraction of CHDM and Y is the mole fraction of DEG; and
II. about 5 to 150 ppm of at least one reheat enhancing aid selected from carbon black, black iron oxide and antimony metal.

9. The composition of claim 1 further comprising at least one UV absorbing compound which is thermally stable at polyester processing temperatures and provides less than about 20% transmittance of UV light having a wavelength of 370 nm through a bottle wall 12 mils thick.

10. The composition of claim 9 wherein said UV absorbing compound has formula I: 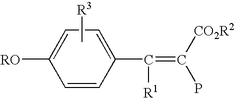
wherein:
R is hydrogen, alkyl, substituted alkyl, aryl, substituted aryl, cycloalkyl, substituted cycloalkyl or alkenyl;
R¹ is hydrogen, or a group such as alkyl, aryl, or cycloalky, all of which groups may be substituted;
R² is any radical selected from the group consisting of hydrogen, alkyl, substituted alkyl, allyl, cycloalkyl or aryl;
R³ is hydrogen or 1-3 substitutents selected from alkyl, substituted alkyl, alkoxy, substituted alkoxy and halogen, and
P is cyano, or a group such as carbamyl, aryl, alkylsulfonyl, arylsufonyl, heterocyclic, alkanoyl, or aroyl, all of which groups may be substituted.

11. The composition of claim 10 wherein R² is hydrogen, alkyl and hydroxyalkyl; R is selected from hydrogen or an alkyl linking group; and P is cyano.

12. The composition of claim 10 where said UV absorbing compound comprises at least two compounds of formula I .

13. The composition of claim 10 wherein said UV absorbing compound is present in an amount between 1 to about 5000 ppm by weight.

14. The composition of claim 10 wherein said UV absorbing compound is present in an amount between about 2 ppm to about 1,500 ppm by weight.

15. The composition of claim 10 wherein said UV absorbing compound is present in an amount between about 10 and about 700 ppm by weight.

16. A process for forming a heat-set container which comprises the steps of:
(1) injection molding the polyester composition of claim 1 to form a container perform;
(2) reheating or temperature conditioning the preform; and
(3) stretch blow molding the preform of step (2) into a mold heated at a temperature of about 90 to 160° C.

17. The process of claim 16 wherein step (3) comprises stretch blow molding the preform of step (2) into a mold heated at a temperature of about 100 to 140° C.

18. A heat set container formed from the composition of claim 1.

19. A heat set container formed from the composition of claim 5.

20. A process for forming a heat-set container which comprises the steps of:
(1) injection molding the polyester composition of claim 8 to form a container perform;
(2) reheating the preform; and
(3) stretch blow molding the preform of step (2) into a mold heated at a temperature of about 100 to 140° C.
